(19) United States
(12) Patent Application Publication
(10) Pub. No.: US 2013/0252529 A1
(43) Pub. Date: Sep. 26, 2013

(54) VENTILATED VEHICLE LOADING FLOOR

(71) Applicants: Lothar Baldsiefen, Koeln (DE); Dino Valter, Duren (DE); René A. Huth, Lohmar (DE)

(72) Inventors: Lothar Baldsiefen, Koeln (DE); Dino Valter, Duren (DE); René A. Huth, Lohmar (DE)

(73) Assignee: Ford Global Technologies, LLC

(21) Appl. No.: 13/848,024

(22) Filed: Mar. 20, 2013

(30) Foreign Application Priority Data
Mar. 23, 2012 (DE) 102012204713.1

(51) Int. Cl. B60H 1/24; B60H 1/00

(52) U.S. Cl. CPC B60H 1/246; B60H 1/00271
USPC 454/144

(57) ABSTRACT

A vehicle loading floor includes: a first rail having a retention groove; and a second rail adjacent the first rail and having ventilation orifices.

### CROSS-REFERENCE TO RELATED APPLICATIONS

This application is a continuation and claims the benefit of German Patent Application No. DE 102012204713.1 titled “Loading floor and profile member for a loading floor” filed Mar. 23, 2012, which is hereby incorporated by reference in its entirety.

### TECHNICAL FIELD

The present disclosure relates to vehicle loading floors, in particular loading floors with ventilation.

### BACKGROUND

The luggage compartments of contemporary vehicles are generally provided with a loading floor. With the increased popularity of vehicles that have flexible luggage compartments that can be used for seating, vehicle floors are more commonly being designed to selectively attach objects to the loading floor. For example floors have attachment features for seating, straps or other devices to be secured thereto. Preferably the loading floor has a flushed face so that when items are not secured to the loading floor the floor has a flat surface that can be utilized for storage.

When the luggage compartment is used for seating it is desirable to heat or cool the seating area. Prior known flooring systems do not accommodate heating and cooling through the flooring system. In Great Britain Patent No. GB 2 353 769 A, titled “Vehicle flooring system” it is disclosed that a vehicle floor has a plurality of pre-shaped flooring components that can be fitted together and hollowed channels which can be used for running guiding cables or ventilation (duct work) therethrough. However, this system does not teach a temperature control structure incorporated into the flooring.

Therefore it is desirable to have a vehicle loading floor that is ventilated or otherwise enabled to control temperature of the floor through structure in the floor.

### SUMMARY

The present disclosure addresses one or more of the above-mentioned issues. Other features and/or advantages will become apparent from the description which follows.

One advantage of the present disclosure is that it teaches a vehicle loading floor that is ventilated and configured to control temperature of the floor through structure in the floor

Another advantage of the present disclosure is that it provides improved air conditioning of a vehicle interior as the vehicle heating ventilation and air conditioning system is tied into the flooring.

One exemplary embodiment relates to a vehicle loading floor including: a first rail having a retention groove; and a second rail adjacent the first rail and having ventilation orifices.

One exemplary embodiment relates to a vehicle loading floor, having: a plurality of profile members extending in a longitudinal direction, arranged adjacently and interconnected; and a first hollowed channel formed in a profile member, extending in the first longitudinal direction and having a lateral opening.

Another exemplary embodiment relates to a profile member for a vehicle loading floor, including: a hollowed channel extending in a longitudinal direction with respect to the profile member; and at least one lateral opening connected to the hollowed channel.

The invention will be explained in greater detail below by way of example with reference to the figures, in which the same reference numbers are used in the figures for identical or essentially identical elements. The above features and advantages and other features and advantages of the present teachings are readily apparent from the following detailed description for carrying out the invention when taken in connection with the accompanying drawings. In the figures:

### BRIEF DESCRIPTION OF THE DRAWINGS

FIG. 1 is a perspective view of an embodiment of a loading floor according to an exemplary embodiment of the present disclosure.

FIG. 2 is an enlarged, perspective view of the loading floor of FIG. 1, taken at circle 2.

### DETAILED DESCRIPTION

Turning now to the figures, where like characters represent the same parts, there is shown therein a vehicle loading floor having a ventilation system incorporated therein. The ventilation system includes hollowed channels running about a length of the profile members (or floor board). A number of ventilation orifices are formed in profile members to provide circulation between a HVAC and different portions of the floor. Vehicle floor is compatible with any type of vehicle including, e.g., trucks, SUVs, cross-overs, hatchbacks, or sedans.

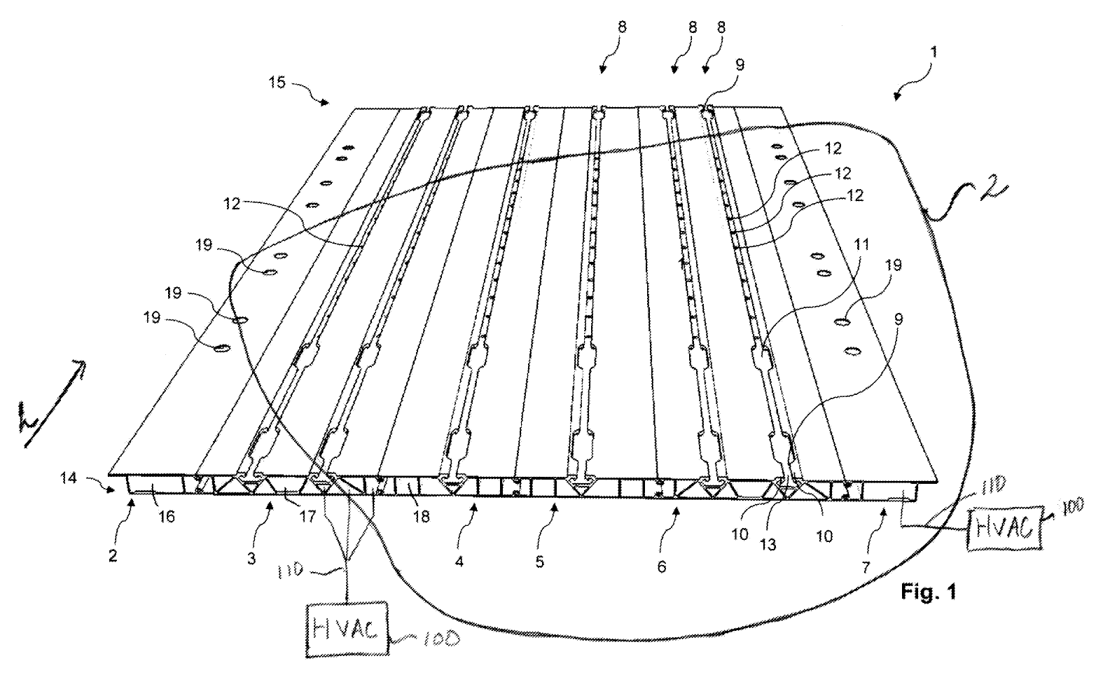

With respect to FIG. 1, there is shown therein a loading floor 1 of a vehicle that includes a plurality of elongate profile members 2, 3, 4, 5, 6, 7. Profile members include edge members 2, 7, intermediate members 3, 6 and central members 4, 5. In the illustrated embodiment of FIG. 1, two central members 4, 5 are constructed in the same manner. Each intermediate member 3, 6 is also identical to each other. Edge members 2, 7 are also identical with the exception of a connection to the intermediate members 3, 6. Profile members 2, 3, 4, 5, 6, 7 are arranged beside each other (or adjacent to each other) and in parallel and connected to each other to form the planar loading floor 1. Floor 1 can be secured to a floor plate or a carrier structure of a vehicle, for example. Profile members extend in a longitudinal direction, L, as shown in FIG. 1.

As also shown in FIG. 1, a plurality of loading rails 8 are integrated in the upper side of the substantially smooth loading floor. Each loading rail 8 has a longitudinal groove 9 which is open in an upward direction and which is partially narrowed, or has a variable enclosure, in the upper region by means of lateral projections 10 in such a manner that a sliding block (or object) that is inserted in the longitudinal groove 9 (or retention groove) can only be removed in an upward direction at the recesses 11. In the portions of the longitudinal groove 9 narrowed by the projections 10, the sliding block can be secured in order to fix a load, for example, via screwing or clamping.

A plurality of bores 12 extend into a continuous elongated hollow space 13 (or hollowed channel) of the profile member 6. At a front end face 14 of the loading floor 1 an air supply for supplying air-conditioning air can be connected to the hollow space 13. At the rear end face 15, the hollow space 13 can be closed, for example, by means of a plug or by means of a seal which is formed when the loading floor is assembled. When the HVAC 100 is powered air is introduced into the hollow space 13 by means of a connected air conditioning air line 110. Air is introduced through the bores 12 and the longitudinal groove 9 into an inner space of the vehicle (or the vehicle interior) located above the loading floor 1. Intermediate members 3, 6 each have, in the embodiment illustrated, two longitudinal grooves 9 that are constructed in this manner. Central members 4, 5 each include a longitudinal groove 9.

The hollow spaces 16 of the edge members 2, 7 are open via bores 19 (or ventilation orifices) in a direction towards the inner space of the vehicle. These bores can have a larger diameter than the bores 12 (or ventilation orifices) in the longitudinal grooves 9 in order to ensure an increased through flow of air-conditioning air in the edge region of the loading floor 1 and consequently in the edge region of the luggage compartment or passenger compartment. At the front end face 14 of the loading floor 1, an air-conditioning air supply line or an air-conditioning air distributor can be connected to the hollow spaces 16 of the edge members 2, 7 and the rear ends of the hollow spaces 16 can be closed (e.g., 100 and 110 as shown in FIG. 1).

Air-conditioning air can also flow through other hollow spaces 17, 18 of intermediate or central members 3, 4, 5, 6 which have no openings with respect to the inner space of the vehicle in order also to better control the temperature of the regions of the loading floor formed by the walls of the additional hollow spaces 17, 18 in accordance with the temperature of the air conditioning air. To this end, the other hollow spaces 17, 18 can be connected at the end side to air conditioning air lines. There can be, for example, air introduced from the front end face 14 of the loading floor into other hollow spaces 17, 18 that have no lateral openings and, via connection lines that are positioned at the rear end face 15 of the loading floor 1, so that the air is directed into the hollow spaces 13, 16 that are provided with bores and are in this instance closed at the front end face 14. Optimal use of the air-conditioning air is provided by the air-conditioning system of the vehicle.

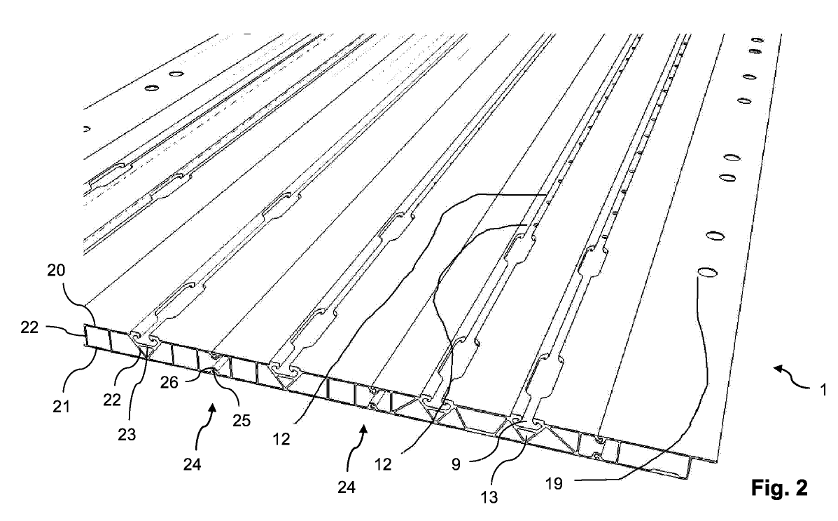

As shown in the enlarged illustration of FIG. 2, the profile members 2, 3, 4, 5, 6, 7 each have at the upper and lower side with a substantially smooth upper structure 20 or lower structure 21. The lower structure 21 is constructed to secure to a carrier structure or a metal floor sheet of the vehicle. The upper and lower structure 20, 21 are connected to each other by means of struts 22 which are continuous in the longitudinal direction in order to increase the rigidity of the loading floor 1. The base of the longitudinal groove 9 can also act as an additional strut 23 that is arranged between two struts 22 in order to improve the stability of the loading floor.

FIG. 2 also shows the connection members 24 that interlock or connect the profile members 2, 3, 4, 5, 6, 7 to each other. In the embodiment illustrated, the connection members 24 are constructed to produce a positive-locking connection, for instance, as lips 25 that form catch grooves in which catch projections 26 engage. The loading floor 1 can be produced from profile members 2, 3, 4, 5, 6, 7 that are produced as extruded profile members that are cut to length and are provided with the bores 12, 19, for example, by being laterally joined together or by being inserted in the longitudinal direction.

A loading floor according to the present disclosure is in particular suitable for a loading or a passenger compartment of a vehicle, but can also be used, for example, as a wall or ceiling covering in a vehicle interior. The profile members are preferably connected to each other in a positive-locking manner but can also be connected to each other in other fastening arrangements, for example, in a frictionally engaging manner, adhesively bonded, welded or connected in another manner. The profile members are preferably produced by means of extrusion, for example, as extruded aluminum profile members. The loading floor, in addition to the profile members, can comprise other members, such as end-face covering caps or members for securing the loading floor to a floor plate or a carrier structure of the vehicle.

Due to the fact that the profile members include a continuous hollow space that has at least one lateral opening that is not continuous in the longitudinal direction, an air-conditioning air stream is directed through the hollow space to be discharged therefrom and reach an outer space of the profile member or the loading floor, e.g., the vehicle interior. In another embodiment, the opening widths of the plurality of openings in the profile member are mutually offset in a longitudinal direction. Opening widths increase in such a manner that, for the discharge of the air-conditioning air from individual openings, a flow resistance is produced which takes into account different path lengths. It is thereby possible to achieve a particularly uniform distribution of air-conditioning air. Air distribution uniformity can also be controlled by orifice dimensions.

In another exemplary embodiment, at least one opening is preferably arranged in a lateral region of the longitudinal groove. It is thereby possible to prevent contamination and obstruction of the opening. However, the at least one opening can also be arranged in a bottom region of the longitudinal groove, where the production of the profile member and the introduction of bores are facilitated.

The profile member, in one embodiment, includes connection members that are constructed, for example, as catch projections and catch grooves for connection to other profile members in order to compose a loading floor from the profile members. In particular, the profile member can be constructed so as to produce a loading floor of the type described above by means of connection to other profile members.

The illustrated profile members are composed of sheet metal. Profile members can be formed using known forming techniques, e.g., extrusion, stamping or milling. In other embodiments profile members can be composed of other materials, e.g., composites or polymers.

Those familiar with the art to which the invention relates will recognize various alternative designs and embodiments for practicing the invention within the scope of the appended claims.

We claim:

1. A vehicle loading floor comprising:
a first rail having a retention groove; and
a second rail adjacent the first rail and having ventilation orifices.

2. The loading floor of claim 1, wherein the first and second rail are configured to interlock.

3. The loading floor of claim 1, wherein the retention groove includes a variable enclosure configured to allow vertical movement of an object positionable in the groove at one location and prevent vertical movement of the object when positioned in the groove at another location.

4. The loading floor of claim 1, wherein the first rail includes ventilation orifices.

5. The loading floor of claim 4, wherein the first rail includes a hollowed channel adjacent the retention groove configured to facilitate circulation between vehicle heating ventilation and air conditioning (HVAC) system and ventilation orifices.

6. A vehicle loading floor, comprising:
a plurality of profile members extending in a longitudinal direction, arranged adjacently and interconnected; and
a first hollowed channel formed in a profile member, extending in the first longitudinal direction and having a lateral opening.

7. The loading floor of claim 6, further comprising:
an upper structure and a lower structure at least partially defining the first hollowed channel; and
a strut connecting the upper and lower structures.

8. The loading floor of claim 6, wherein the first hollowed channel is connected to an air conditioning line at an end region of the profile member.

9. The loading floor of claim 6, wherein the loading floor includes a plurality of orifices.

10. The loading floor of claim 9, wherein the plurality of orifices are configured with different sized diameters.

11. The loading floor of claim 6, further comprising:
second hollowed channel formed in a profile member connected to the first hollowed channel.

12. The loading floor of claim 6, further comprising:
a longitudinal groove formed in the profile member; and
a plurality of orifices in fluid communication with the longitudinal groove.

13. The loading floor of claim 12, further comprising:
a second hollowed channel adjacent the longitudinal groove, configured to connect an air distributor to the longitudinal groove.

14. The loading floor of claim 12, wherein the plurality of orifices are formed in a bottom region of the longitudinal groove.

15. A profile member for a vehicle loading floor, comprising:
a hollowed channel extending in a longitudinal direction with respect to the profile member; and
at least one lateral opening connected to the hollowed channel.

16. The profile member of claim 15, further comprising:
an upper structure and a lower structure at least partially defining the hollowed channel; and
a strut connecting the upper and lower structures.

17. The profile member of claim 15, further comprising:
a plurality of orifices found in the profile member.

18. The profile member of claim 17, wherein the plurality of orifices have different sized diameters.

19. The profile member of claim 15, further comprising:
a longitudinal groove formed in the profile member; and
plurality of orifices in fluid communication with the longitudinal groove.

20. The profile member of claim 19, wherein the longitudinal groove includes a variable enclosure configured to allow vertical movement of an object positionable in the groove at one location and prevent vertical movement of the object when positioned in the groove at another.
